(19) United States
(12) Patent Application Publication
(10) Pub. No.: US 2007/0130035 A1
(43) Pub. Date: Jun. 7, 2007

(54) SYSTEM AND METHOD FOR THE PROVISION OF A FINANCIAL PRODUCT

(75) Inventor: Philip James Albert Carden, Sackbille North (AU)

Correspondence Address: KNOBBE MARTENS OLSON & BEAR LLP, 2040 MAIN STREET, FOURTEENTH FLOOR, IRVINE, CA, 92614, US

(73) Assignee: Life House Finance Corporation Pty Limited, Sackville North (AU)

(21) Appl. No.: 11/557,623

(22) Filed: Nov. 8, 2006

Related U.S. Application Data
(63) Continuation of application No. PCT/AU05/00667, filed on May 10, 2005.

(30) Foreign Application Priority Data
May 10, 2004 (AU) 2004902453
Aug. 25, 2004 (AU) 2004904857

(51) Int. Cl. G06Q 40/00

(52) U.S. Cl. 705/35

(57) ABSTRACT

A method is described for enabling a plurality of consumers to receive a term of life periodic payment from a financial product provider. The financial product provider secures an interest for a predetermined value over assets owned by the consumers, and calculates a series of period payments based on the expected life expectancies of the plurality of consumers. Payments are provided until a consumer dies, at which time a final payment is recovered by the financial product provider. A computer system is also provided to implement the abovementioned method.

### CROSS-REFERENCE TO RELATED APPLICATIONS

This application is a continuation of PCT Patent Application No. PCT/AU2005/000667 filed on May 10, 2005 which claims priority of Australian Patent Application No. 2004902453 filed on May 10, 2004, and of Australian Patent Application No. 2004904857 filed on Aug. 25, 2004, the disclosures of which are incorporated herein in their entirety by reference.

### FIELD OF THE INVENTION

The present invention relates to a method and system for the provision of a financial product.

### BACKGROUND OF THE INVENTION

Many Western societies are faced with the growing problem of financially supporting a burgeoning older and retired population. When a person retires, their disposable income generally decreases dramatically, but the person commonly holds an appreciable amount of low liquidity assets. That is, assets that are not readily convertible into cash or an income stream. For many people, the primary asset they hold is the family home.

Naturally, as the person wishes to continue to reside in their family home, selling the family home in order to provide a retirement income is not a viable or appealing option. Furthermore, a person who is retired and on a low fixed income does not have the capacity to mortgage their family home, as they do not have access to an income stream to meet repayments on any mortgage secured against their home.

One possible solution is the so-called “reverse” mortgage. With a reverse mortgage, the home owner borrows an amount of money, which is secured against a mortgage over their home. They are not required to make any repayments on the money borrowed, but the interest payable on their mortgage is added to their total debt. Then, when they die or no longer continue to live in their home, the home is sold and the total amount due on the mortgage is repaid from the proceeds of the sale.

Such mortgages are problematic for a number of reasons. Firstly, they are risky for the lender, as certain assumptions regarding the longevity of the home owner and the capital gain of the property must be factored into the lending risk. If the capital gain on the property is low, or if the borrower lives for longer than expected, there is a risk that the total amount owed by the borrower will surpass the value of the property.

As a corollary, the reverse mortgage is a risk for the borrower, as their property may be repossessed if the value of their loan exceeds the value of their property, which will occur with greater speed should the rate of interest charged by the lender be variable, and that rate were to rise.

Moreover, in some jurisdictions, lenders have been prevented from repossessing property, as reverse mortgages have been set aside by courts of law on the grounds that they are unfair to borrowers. Subsequently, a ‘no negative equity’ provision is standard industry practice for reverse mortgage contracts. This has resulted in a situation where few financial institutions will offer reverse mortgages. The financial institutions that do offer reverse mortgages impose very strict conditions and only offer to lend very small amounts of money (in comparison to the present value of the property). Despite historical occurrences of variable interest rate volatility and evidence that such volatility, if repeated, would result in even the smallest amounts of loan advances compounding to exceed property values, such products dominate the reverse mortgage landscape.

Furthermore, demand for money by an aging population will grow into the hundreds of billions of dollars in Australia alone as the population ages and Government revenue falls short of being able to support the social policy needs of the aging population. Any solution must be capable of providing a large amount of liquidity, if it is going to ameliorate this problem. Due to the fact that reverse mortgages have term of life, interest rate and capital gains risk, domestic and international capital markets are not able to liquify these existing reverse mortgage structures at the required level of hundreds of billions of dollars.

Therefore, current reverse mortgage products do not adequately alleviate the problem of providing asset-rich but income-poor retirees with a steady source of income. Reverse mortgages provide an unacceptable level of risk to adequately deliver the amount of liquidity that society will demand in the coming years.

### SUMMARY

A first aspect provides a method for enabling a plurality of consumers to receive a term of life periodic payment from a financial product provider, comprising the steps of, the provider securing an interest in a percentage of the value of assets owned by the plurality of consumers, calculating a series of periodic income payments payable to each of the plurality of consumers, the series of periodic income payments being dependent on the expected life expectancy for each of the plurality of consumers, providing the payments to each of the plurality of consumers until death, and on the death of a consumer, recovering a final payment payable to the financial product provider.

In one embodiment, the method comprises the further step of calculating the series of periodic payments by determining a future value of the asset utilizing an estimated value of the asset and a predetermined loan to value ratio, utilizing the future value to calculate a present value, and utilizing the present value and the expected life expectancy of the consumer to calculate the value of each one of the series of periodic payments.

The method may further comprise the step of, on the death of a consumer in the plurality of consumers, calculating the final payment payable to the financial product provider.

The calculation of the final payment may be based on the total number of periodic income payments provided to the consumer during their lifetime and a fixed margin lending rate charged by the provider, wherein the final payment is deducted from the disposed value of the asset and the remaining portion of value of the disposed asset is refunded to the estate of the consumer. Should the final payment amount due to the provider exceed the disposed asset value, the provider may accept the disposed asset value as the final payment.

The method comprises the further step of pooling the obligations of the financial product provider to the plurality of consumers, and the cashflow obligations of the plurality of the consumers' assets to the financial product provider. The pool of assets and cash flow obligations may be placed in a separate legal entity to facilitate capital raising used to fund the timing differences in cashflow dates. The separate legal entity may take the form of a ‘Special Purpose Vehicle’ (SPV) that would be managed by the financial product provider and would retain first mortgage charges over the assets in the pool.

The method may comprise the financial product provider intermediating an agreement with a third party (such as a bank) whereby the present value of the plurality of term of life payments to consumers is exchanged for the present value of the plurality of final payments due to the financial product provider. Such a method would calculate present values using differing interest rates, representing the price at which the bank would buy and sell future cash flows delivered by the financial product provider into the separate legal entity.

In this embodiment, the method would rely upon the application of fixed mortality expectations to determine fixed future cashflows. The method would subsequently derive a predicted present value gross lending profit to the financial product provider that would occur if actual consumer mortality replicated the fixed mortality expectations that the bank relied upon.

The method may include a facility to meet the variance in cashflow obligations in situations where the pool mortality varies from the expected mortality, such that cash flow falls short of that required under combined swap and loan obligations.

The facility, known as the “Reserve Account”, may be funded by the bank, the financial product provider retaining a percentage of the financial product provider gross profit margin. The Reserve Account may first meet payment shortfalls under the consumer contracts and secondly meet shortfalls in expected loan repayments. In this embodiment, the size of the reserve account would be sufficient to satisfy the mortality stress test as required by the financial product provider banker. The embodiment will also serve to provide liquidity and ensure that projected cashflows assumed by the bank can be met in a timely manner, ensuring that the bank can determine its' own lending internal rate of return (IRR).

An alternative embodiment would allow for a Life Insurance Company to use its balance sheet in place of the SPV, thereby funding the consumer cash flows by providing life insurance policies to a pool of consumers, in return for a periodic payment, the periodic payment being utilized to fund the term of life annuity payments.

This alternate embodiment effects an arbitrage, created by hedging the life insurance policy assets and liabilities against the assets and liabilities of the plurality of Equity Release Annuity consumers. The cashflow is matched in so far as the mortality expectations of life insurance consumers are matched to the mortality expectations of Equity Release annuity income consumers. This embodiment uses the Life Insurance Consumers policy payments to fund the Equity Release Annuity Consumers annuity payments and the Equity Release Consumers loan repayment is used to fund the Life Insurance Consumers indemnity on death, hence matching out and hedging mortality risk.

One embodiment advantageously allows a consumer to receive regular income payments for the term of their natural life, irrespective of their actual date of death, whilst simultaneously managing the exposure of the provider by balancing the regular payment against an asset owned by the consumer.

A second aspect provides a computing system for enabling a consumer to receive a term of life periodic payment from a financial product provider in exchange for an interest over assets owned by a plurality of consumers, comprising means for calculating a series of periodic income payments payable to each of the plurality of consumers, the series of periodic income payments being dependent on the expected life expectancy for the each of the plurality of consumers, means for providing the payments to each of the plurality of consumers until the death of the consumer, and on the death of the consumer, means to dispose of the asset to recover a final payment to the provider.

The system may include means for storing a contract setting out the terms of an agreement between the consumer and the provider.

The system may further include the step of receiving information from the consumer.

A third aspect provides a system for providing a series of periodic payments to a plurality of consumers from a provider, comprising means to regulate a legal relationship between the provider and each one of the plurality of consumers, the means having a plurality of predetermined conditions, including a first condition which requires each one of the consumers to render to the provider an interest for a predetermined value over an asset owned by the consumer, a second condition that requires the provider to calculate and render to each one of the plurality of consumers a series of periodic income payments for the lifetime of the consumer, the series of periodic income payments being dependent on the expected life expectancy of the consumer, and a third condition which, on the death of the consumer, allows the provider to dispose of the asset to receive a final payment as consideration for the provision of the series of periodic payments.

In this embodiment, the legal relationship is affected by a contract.

A fourth aspect provides a method for enabling a plurality of consumers to receive a term of life period payment from a financial product provider, comprising the steps of the provider securing an interest for a predetermined value over assets owned by the plurality of consumers; calculating a series of period income payments payable to each of the plurality of consumers; the series of period income payments being dependent on the expected life expectancy of the plurality of consumers; and providing a guarantee that the payments will be made to each of the plurality of consumers until death.

### BRIEF DESCRIPTION OF THE DRAWINGS

Notwithstanding any other forms which may fall within the scope of the invention, preferred forms of the invention will now be described, by ways of example only, with reference to the accompanying drawings in which:

FIG. 1 is a computing system utilized to implement a method in accordance with one embodiment;

FIG. 2 is a flowchart that depicts a process in accordance with one embodiment.

FIG. 3 is an illustration of an offer that a financial product provider can make to a consumer.

FIG. 4 is an example of a spreadsheet that may be used by an embodiment of a computer program to implement the process of FIG. 2.

### DETAILED DESCRIPTION OF CERTAIN INVENTIVE EMBODIMENTS

A method in accordance with one embodiment will now be described with reference to three parties, namely a consumer, a financial product provider, and a banker. However, it will be understood that in other embodiments, the consumer may interact directly with an investor who is a life insurance company that intermediates the entire process of issuing the Annuity and funding it by using life insurance policy cash flows and such a variation is encompassed by some embodiments.

In describing a method in accordance with an embodiment, a number of terms and acronyms are utilized. These terms include:
Consumer: The consumer is a legal person who purchases a product from the financial product provider, in accordance with an embodiment.
Special Purpose Vehicle (SPV): The special purpose vehicle is any legal or financial structure appropriate for the execution of a method in accordance with an embodiment. In most instances, the SPV will be a company structure, but other structures such as trusts, partnerships, etc., may be appropriate in certain situations.
Banker: The banker is an establishment that provides and receives mortality dependent cashflows to and from the SPV managed by the financial product provider. In the following examples, the cash flows paid to the SPV are titled ‘Schedule A’. The cashflows received by the banker, from the SPV, are titled ‘Schedule B’. The Banker may be a Life Insurance Company.
Financial Product Provider: The financial product provider is the financial product provider and the manager of the SPV that facilitates the cashflow exchanges between the consumer and the banker.
Equity Release Annuity (EQRAT): The Equity Release Annuity is a number of periodic payments made to the Consumer, by the SPV, until a mortality event. Upon the occurrence of a mortality event, a mortality Payment Date is reached at which time the consumer makes the EQRAT Mortality Payment to the SPV. If payments occur on a monthly basis then the period is monthly and if the payments occur on a quarterly basis then the period is quarterly.
CPI Linked Equity Release Annuity (CEQRAT): The CEQRAT is identical to the EQRAT except that the periodic payments are linked to the CPI. The periodic payments will increase at the same percentage as the CPI. Upon the occurrence of a mortality event, a mortality Payment Date is reached at which time the consumer makes the CEQRAT Mortality Payment to the SPV. If payments occur on a monthly basis then the period is monthly and if the payments occur on a quarterly basis then the period is quarterly.
Bequeathment Estate Guarantee (BEG): The Bequeathment Estate Guarantee is a fixed percentage of a consumer's Property (Asset) Valuation. The BEG allows the consumer to quarantine a predetermined percentage of the liquidated value of the consumers real estate asset to be bequeathed to the consumers estate following death. The BEG is granted by the Lender to the Consumer and it guarantees that an agreed percentage of the sale price of the mortgaged asset will be paid to the consumer's estate for distribution to beneficiaries irrespective of the consumers obligations under the Mortality Payment.
RELIB Mortality Payment: RELIB Mortality Payment is an amount of money paid by the Consumer to the SPV on the Mortality Payment Date.
EQRAT Mortality Payment: Equity Release Mortality Payment is a final payment paid by the Consumer's estate to the SPV on the Mortality Payment Date.
CEQRAT Mortality Payment: Equity Release Mortality Payment is a final payment paid by the Consumer's estate to the SPV on the Mortality Payment Date. The CEQRAT Mortality Payment value is determined in exactly the same way as the EQRAT Mortality Payment, for although the consumer receives a CPI Linked Annuity, their loan repayment (final payment) is determined by a nominal loan schedule.
Reverse Life Insurance Bond (RELIB): The RELIB is a plurality of EQRAT's and CEQRAT's pooled together and sold to or integrated into a Life Insurance companies investment portfolio for the purpose of investing and hedging the proceeds and obligations of life insurance policies.
LVR: LVR is the percentage rate that is the future value of the Equity Release Annuity as a percentage of the consumer's asset value now or its expected value at a future date.
Term of Life: This is the duration of the annuity or its term. The term of life is calculated by counting the number of (C)EQRAT payments that are made beginning on the first (C)EQRAT Payment and counting each monthly payment until the last monthly payment is made too the Consumer, usually ending on the Mortality Payment Date.
Mortality Payment Date: The Mortality Payment Date is a date (normally four months) after the most recent (C)EQRAT payment was made prior to the consumer's death.
Fixed Rate: The Fixed Rate is an interest rate used to calculate Mortality Payments and Annuities. The Fixed Rate is derived using Consumer Life Expectancy and the Yield Curve.
Yield Curve: The Yield Curve is a series of Fixed Interest Rates that relate to interest rate levels as they apply to different loan terms on a specific day, usually the day of the First EQRAT and RELIB Payments. Yield Curve rates are fixed rates and can be used to calculate the present or future value of known payments on known dates. The rates used to construct the Yield Curve are known as fixed rates.
RELIB A Margin: RELIB A Margin is an interest margin subtracted from the Fixed Rate. The sum of the RELIB A Margin and the Fixed Rate is used to calculate the present value of Schedule A.
RELIB B Margin: RELIB B Margin is an interest margin added to the Fixed Rate. The Sum of the RELIB B Margin and the Fixed Rate is used to calculate the Present Value of Schedule B.
EQRAT Margin: The EQRAT Margin is an interest margin added on to the Fixed Rate. The sum of the Equity Release Margin and the Fixed Rate is used to calculate the EQRAT Payment and the EQRAT Mortality Payment.
CEQRAT Margin: The CEQRAT Margin is the summation of a CPI Margin, expressed as an interest rate, and the EQRAT Margin. The sum of the CPI Equity Release Margin and the Fixed Rate is used to calculate the CEQRAT Payment, but not the CEQRAT Mortality Payment.
Property (Asset) Value: This is an official valuation of the consumer's property at a time shortly prior to the (C)EQRAT facility being offered to the Consumer by the financial product provider.
Life Expectancy: The number of years times twelve plus six, a person is expected to live based upon their current age, sex and marital status. The number is multiplied by twelve in order to calculate the number of periodic payments, which occur on a monthly basis in this embodiment. This number is calculated using the Australian Bureau of Statistics publication entitled “Deaths” under the heading “Australian Life Table”. Similar publications exist in other jurisdictions.
Actual Life Expectancy: The number of years times twelve, a person is expected to live based upon their current age. This number is calculated using the Australian Bureau of Statistics publication entitled “Deaths” under the heading “Australian Life Table”. Similar publications exist in other jurisdictions.
CPI Linked Interest Rate Swap: The financial product provider as manager for the SPV will generate contractual obligations with the bank to exchange nominal cashflows for CPI linked cashflows at a fixed price, termed a ‘CPI Linked Interest Rate Swap (IRS)’.
CPI Margin: The fixed price of the CPI Linked IRS will be determined by the bank nominating the fixed CPI Margin upfront, thereby forecasting cashflow obligations to enable discounting. The CPI Margin may also be referred to as the ‘BEI’ being the acronym for ‘break even inflation’.
BEI: The CPI margin which, if exceeded on average over the weighted average life of cashflow payments, will cost the bank more money than was exchanged upfront.
Schedule A: The financial product provider as manager of the SPV will generate contractual loan obligations to consumers to advance monthly in arrears annuity payments, either nominal or CPI linked, known as EQRAT and CEQRAT payments respectively, for the period until the mortality event. Those cashflows are calculated upon statistical mortality expectations of the consumer's life expectancy. Singularly or collectively, the SPV will contract with the banker to provide those cashflows to the SPV, and the subsequent cashflow obligations of the banker to the SPV are known as ‘Schedule A’.
NPV of Schedule A: is calculated using a margin below the fixed interest rate swap curve yield for each fixed cashflow in Schedule A.
Schedule B: The Consumer, by entering into a contract with the financial product provider, will obligate their estate to a final payment upon a mortality event. Should the loan balance exceed the value of the security mortgaged, the loan balance will be forgiven. These cashflows are predicted given reliance upon statistical mortality expectations of the consumer's life expectancy, adjusted for “loan forgiveness” basis forward property price expectations using S&P rated expectations. Singular or collectively, the SPV will contract with the banker to provide those cash flows to the banker, and the subsequent cashflow obligations of the SPV to the banker are known as ‘Schedule B’.
NPV of Schedule B is calculated using a margin above the fixed interest rate swap curve yield for each fixed cashflow in Schedule B.
The Reserve Account: The Banker will establish and manage a reserve account that is available to facilitate variance in cashflow obligations in situations where the consumer pool mortality varies from the statistically expected mortality, such that SPV cash flow falls short of that predicted in Schedule A and Schedule B.

The Reserve Account will be funded by the lender retaining a percentage of the NPV differential between Schedule A and B. The Reserve Account will first meet payment shortfalls under the consumer contracts (Schedule A), secondly shortfalls in expected loan repayments (Schedule B). The size of the reserve account will be sufficient to satisfy the most stringent mortality stress test. It will serve to provide SPV liquidity and ensure that projected cashflows assumed by the banker can be met in a timely manner, ensuring that the banker can rely on the present value of the Schedule B to deliver its' required IRR.
Mortgage: A security interest over real estate taken by a lender, granted by a borrower and governed by the terms of a contract.
Charge: A security interest granted by an incorporated entity to a lender and governed by a contract.

One embodiment provides a fixed rate term of life annuity to a consumer who holds assets in the form of property (real estate). The purchase consideration for the annuity is paid posthumously by the deceased consumer's estate. The posthumous payment is secured by the consumer either granting the financial product provider (i.e. the special purpose vehicle, or SPV) a first registered mortgage over that property.

An investment vehicle that is dubbed a Reverse Life Insurance Bond (RELIB) funds the process. The SPV enters into a contract with a banker to receive a schedule of annuity payments, either fixed or CPI linked, known as Schedule A.

In exchange, the SPV is obliged to make a fixed schedule of nominal payments to the banker, known as Schedule B.

The Present Value of Schedule A and Schedule B is also Exchanged by the SPV and the Banker.

The contract will state the basis upon which the annuity payments and the RELIB mortality payments are calculated.

The RELIB calculation uses a Life Expectancy Fixed Rate to calculate the annuity payments and mortality payments. The consumers' mortality payment to the SPV is the basis for Schedule B and is paid in arrears after the SPV has satisfied its obligation to pay the consumer the annuity payment.

The SPV in return, grants security to the banker, in consideration for the banker making the annuity payments to the SPV before the SPV makes the mortality payment to the banker. This security is in the form of a first registered mortgage over a property. Other arrangements may also be envisaged, such as a mortgage or a charge over the financial product provider and SPV corporate entities that in turn holds a first registered mortgage over the property.

Under the RELIB the banker is repaid by receiving a series of fixed payments as determined by Schedule B, funded by cashflow triggered by the actual death of the consumer and or the balance of the reserve account.

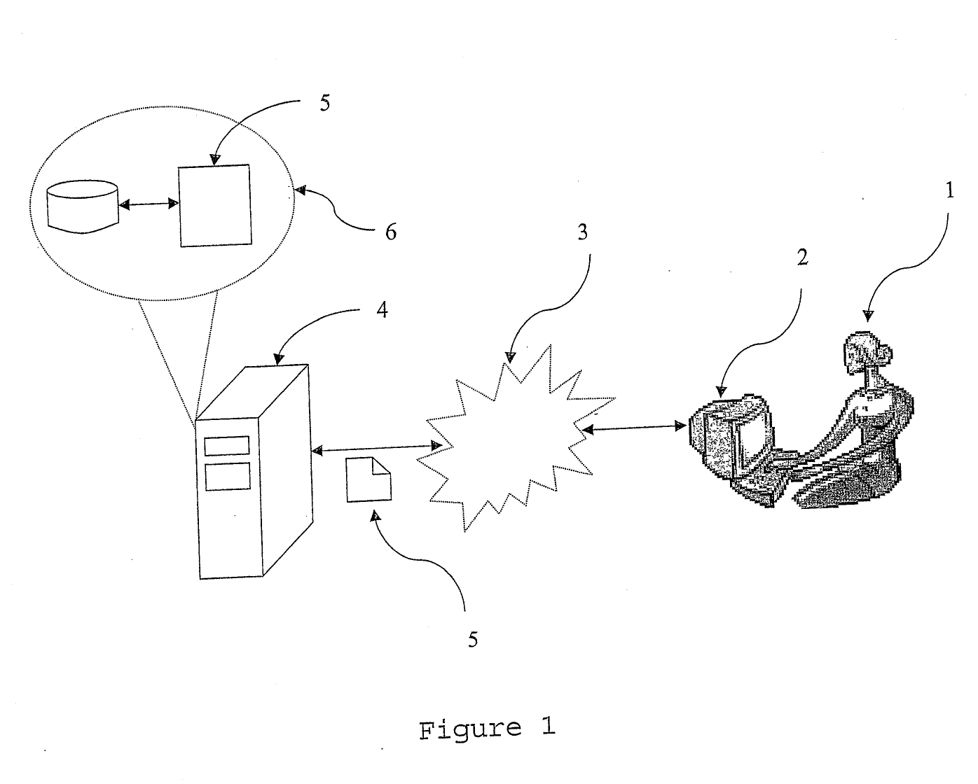

Referring to FIG. 1, consumer 1 makes an application (for example, via a web browser 2 connected via the Internet 3 to a central server 4) to receive a standard periodic payment in return for mortgaging their home. The consumer will be required to input information 5, such as the present value of their home, their age, date of birth, marital status, spouses' age, as well as appropriate contact details including their name, age address and other contact details. The central server will contain information regarding the “Yield Curve”, EQRAT, CEQRAT and RELIB margin. The central server may include appropriate calculating means 6, which, when given the consumer's details as input information 5, calculates the likely periodic payment the consumer can receive in return for mortgaging their home (the algorithm utilized is described in more detail below). This payment may be presented to the consumer 1 via the web browser interface 2. Once presented with the information, the consumer may then make a decision as to whether to proceed with the application. If the consumer proceeds, the consumer will be referred to a representative, who will then meet or interact with the consumer in any suitable manner to prepare an appropriate contractual agreement and other legal documents as required to give effect to the legal relationship. It will be understood that the processing of the contract could be carried out “online” if so desired.

The contract requires the consumer to grant a mortgage to the financial product provider. The financial product provider operates within a special purpose vehicle. It will be understood that the special purpose vehicle may be a corporation, an unincorporated body, a partnership or any other suitable organisation that is capable of conducting business, and that some or all of the method steps may be carried out by a person, or by a computing system arranged to receive information from both the consumer, the financial product provider, the investor, or any combination thereof.

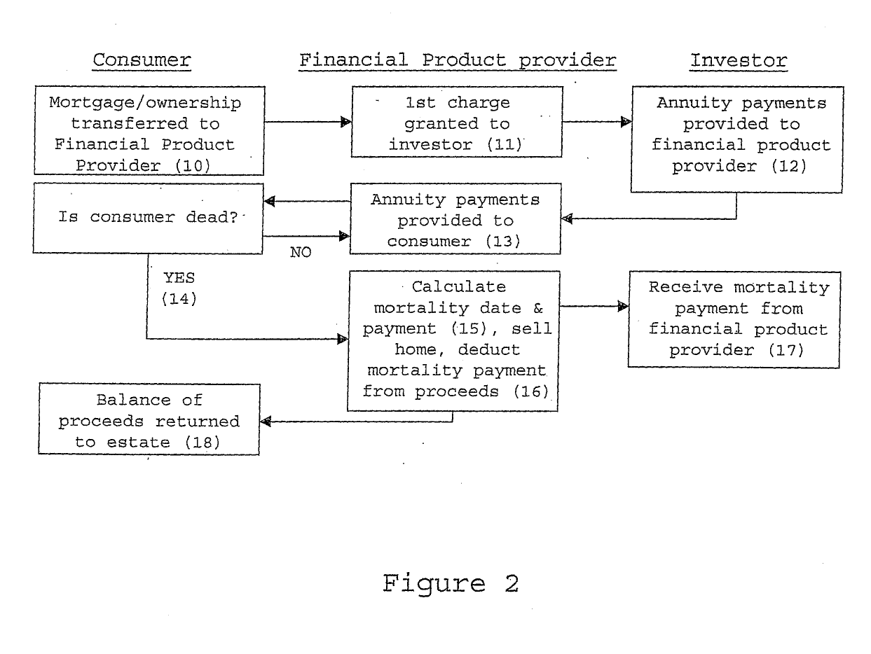

Referring to FIG. 2, once the contract is approved and executed, the mortgage is granted to the financial product provider or ownership of the property is transferred (10). In some circumstances the mortgage may be held (“warehoused”) until a pool of mortgages is collected. This may be done to satisfy the investor's minimum parcel requirements. The financial product provider grants first charge over the mortgage/pool to an investor (11). In return for receiving a first charge over the mortgage to the property, the investor provides the financial product provider with annuity payments (12).

The algorithm by which the annuity payments are calculated will be described in more detail later. The annuity payments are received by the financial product provider, and are subsequently forwarded to the consumer (13). The annuity payments continue until the consumer expires (dies) (14). Once the consumer has expired, the Mortality Payment Date is determined (15), and utilizing the Mortality payment date, the Equity Release Mortality payment is calculated.

Once the Mortality Payment is calculated, the property is sold and the Mortality Payment is deducted from the sale proceeds, and the SPV receives the Mortality Payment (16). The banker releases the mortgage from the charge completing the transaction. Any amount remaining in excess once the Mortality Payment has been deducted, is returned to the estate of the consumer (18).

If the Mortality Payment amount exceeds the net sale proceeds of the house, the excess will be ‘forgiven’ by the financial product provider.

It will be understood that any or all of the abovementioned method steps may be performed by a computing system.

A more specific worked example of the method in accordance with one embodiment will now be described.

Stage 1—The Consumer Grants Mortgage to Financial Product Provider

The mortgage is granted to a financial product provider in consideration of the financial product provider selling the consumer an EQRAT on terms that include the purchase consideration being paid in arrears posthumously. Prior to the mortgage being granted the financial product provider must make an offer and have that offer accepted.

To make the offer the financial product provider calculates the offer using the following inputs to the following algorithm. The input values are sample values for the purpose of more clearly illustrating the example:

Real Estate Value=$1,250,000.00

Real Estate Appreciation rate=0.00%

LVR=90.00%

Fixed Rate=6.00%

EQRAT Margi=2.00%

Life Expectancy=21 years

BEG=20.00%

CPI Indexed margin=2.50%

(a) Calculate Real Estate Future Value
Equals Real Estate Value times one plus Real Estate Appreciation rate raised to the power of life expectancy in months:

$$\begin{matrix} = RE Value \times ( {( 1 + ( Property Growth / 12 ) )}^{( life expectancy ( in years ) \times 12 )} ) \\ = \$1 \text{,} 250 \text{,} 000 \times {( 1 + 0 )}^{21 * 12} \\ = \$1 \text{,} 250 \text{,} 000\end{matrix}$$

(b) Calculate EQRAT Future Value
Real Estate Value minus Real Estate value times BEG times LVR:
   ($1250000−(1,250,000*0.20))*0.9=$900000
This is the amount of money the financial product provider will charge the consumer in consideration for the financial product provider providing the EQRAT Payments. This calculation assumes the mortality payment date will be equal to the last day of the consumer's life expectancy (as derived from the book “Deaths”).

(c) Calculate Present Value (PV) of EQRAT Future Value Using Fixed Rate and EQRAT Margin

$$PV = [ 1 / {( 1 + ( \frac{( Fixed Rate + EQRAT Margin )}{12} ) )}^{Life Expectancy} ] \times FV$$

$$PV = [ 1 / {( 1 + ( \frac{0.08}{12} ) )}^{252} ] * \$900 \text{,} 000.00 = \$168 \text{,} 674.35$$

The Present Value of the EQRAT Future Value is calculated using the life expectancy figures taken from the publication “Deaths”.

(d) Calculate the PV of a $1.00 Annuity Paid Monthly for the Life Expectancy at the EQRAT Margin Plus Fixed Rate

$$an = \frac{\begin{matrix}( 1 - ( ( 1 / ( 1 + ( ( Fixed Rate + \\ {EQRAT Margin ) / 12 ) )}^{Life Expectancy} ) ) )\end{matrix}}{( ( Fixed Rate + EQRAT Margin ) / 12 )}$$

$$an = \frac{( 1 - ( ( 1 / {( 1 + ( 0.08 / 12 ) )}^{252} ) ) )}{( 0.08 / 12 )}$$

$$an = \$121 .89$$

(e) Calculate the Dollar Value of the EQRAT Payment

$$\begin{matrix}EQRAT Payment = \frac{PV of EQRAT FV}{an ( value in ( c ) PV of \$1 .00 annuity )} \\ = \frac{\$168 \text{,} 674.35}{\$121 .89} \\ = \$1 \text{,} 383.85\end{matrix}$$

(f) Calculate the Dollar Value of the CEQRAT Payment for the Same Consumer Details
This is the same algorithm modified such that where the EQRAT Margin is used the EQRAT margin plus the CEQRAT Margin is substituted. Using the following example values:
Real Estate Appreciation rate 0.00%
LVR 90.00%
Fixed Rate=6.00%
EQRAT Margin=2.00%
Life Expectancy=21 years
BEG=20.00%
CPI Indexed margin=2.50%

(g) Calculate CPI Indexed Margin Monthly (Mthly)
=((1+CPI Margin)ˆ(1/12)−1)*1
=2.472%

(h) Calculate the CPI Compound Factor
CCF=(1+(CPIMthly/12))ˆA Months Life expectancy
=1.6796

(i) Calculate the CPI Annuity Discount Factor
CPI ADF=Annual CPI/CCF
=1.49%

(j) Calculate Real Estate Future Value
Equals Real Estate Value times one plus Real Estate Appreciation rate raised to the power of life expectancy in months:

$$\begin{matrix} = RE Value \times ( {( 1 + ( Property Growth / 12 ) )}^{( life expectancy ( in years ) \times 12 )} ) \\ = \$1 \text{,} 250 \text{,} 000 \times {( 1 + 0 )}^{21 * 12} \\ = \$1 \text{,} 250 \text{,} 000\end{matrix}$$

(k) Calculate CEQRAT Future Value
Real Estate Value minus Real Estate value times BEG times LVR:
   =($1250000−(1,250,000×0.20))*0.9=$900000
This is the amount of money the financial product provider will charge the consumer in consideration for the financial product provider providing the CEQRAT Payments. This calculation assumes the mortality payment date will be equal to the last day of the consumer's life expectancy (as derived from the book “Deaths”).

(l) Calculate Present Value (PV) of CEQRAT Future Value using Fixed Rate and EQRAT Margin and the CPI Indexed Margin
PV=(1/(1+((fixed rate+EQRAT Margin+CPI ADF)/12))ˆMonths Life Exp*CEQRAT FV.
PV=(1/(1+((6%+2%+1.49%)/12)ˆ252*$900,000
PV=$123,674.53
The Present Value of the CEQRAT Future Value is calculated using the life expectancy figures taken from the publication “Deaths”.

(m) Calculate the PV of a $1.00 Annuity Paid Monthly for the Life Expectancy at the EQRAT Margin plus the CPI Margin Plus Fixed Rate
An=(1−((1/(1+((Fixed Rate+EQRAT Margin+CPI ADF)/12))ˆMonths Life Expectancy)))))/((Fixed Rate+Margin+CPI ADF)/12)
An=(1−((1/(1+((6%+2%+1.49%)/12))ˆ252)))))/((6%+2%+1.49%)/12)
An=$109.09

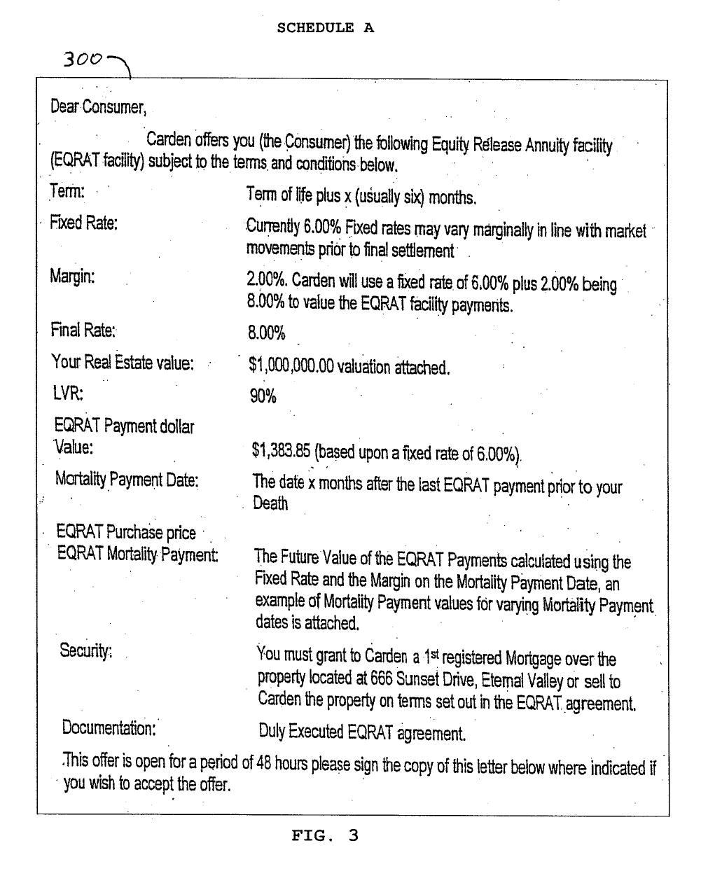

(n) Calculate the Dollar Value of the CEQRAT Payment
CEQRAT Payment=PV of CEQRAT/ann($1)
   =$123,674.93/109.09
   =$1,133.69
   Both the EQRAT and CEQRAT example payment amounts are simplified as they are calculated making the critical presumption about cashflow payments and receipts and mortality events. For example:
A consumer aged 60 years+1 day is in the example above estimated to have an equivalent life expectancy of a consumer aged 60+364 days.
Whilst the average life expectancy for a 60 year old may be 21 years in the example, the final loan repayment will follow mortality by a period estimated at 6 months.
   Subsequently the EQRAT and CEQRAT payment calculations offered will vary slightly as a function. The CEQRAT will have a greater variation because of the dual compounding influence of CPI indexing and the lending interest rate.
   Additionally, as shown by the examples below, the average life expectancy as a measurement input for annuity loan calculations is useful as a simplistic explanation, but in reality, adjustment in the life expectancy is required to accommodate the impact of mortality volatility around the ‘mean’. utilizing these final figures, the financial product provider can make an offer to the consumer. The offer may be made in a form 300 as shown in Schedule A in FIG. 3, although it will be appreciated that the offer may be made in any suitable form, as dictated by local laws and practice.

If the offer is accepted, the financial product provider prepares an agreement, dubbed the EQRAT or CEQRAT facility agreement, for the consumer to execute. This agreement will generally be in the form of a contract, which may be electronic. The contract is a means for establishing a legal relationship between the consumer and the financial product provider.

The EQRAT or CEQRAT facility agreement will set out the EQRAT or CEQRAT payments and the method of calculating the Mortality Date and the Mortality Payment. The agreement will also set out the financial product provider's rights with respect to the property and the procedure for liquidation of the property. The Facility document will also set out the terms upon which the financial product provider is taking a Mortgage.

Following the Execution of EQRAT or CEQRAT Facility documentation, the Consumer will grant the Mortgage to the financial product provider.

2. The Financial Product Provider Grants a Mortgage or a Fixed Charge Over a Pool of Mortgages to the Banker.

The financial product provider is required to fund the CEQRAT and EQRAT Payments, via an SPV, which is achieved by arranging a Reverse Life Insurance Bond (RELIB) with a banker.

The RELIB may be issued in any appropriate way, although for the purposes of this example, the RELIB is issued on the following terms governed by a contract between the financial product provider and the Banker(s).

(a) A number of EQRAT and CEQRAT facilities are grouped into a pool, say 1000 for example, and a database is set up listing the Life Expectancy, Fixed Rate, (C)EQRAT Margin and (C)EQRAT Payment for each (C)EQRAT facility.

(b) The facilities are pooled by the financial product provider by establishing a Special Purpose Vehicle (SPV) and having the Consumers (C)EQRAT Facility Agreements executed with the SPV entity as facility provider. The SPV is then in the position where it is the (C)EQRAT provider to many (C)EQRAT Consumers and can use them to form a Pool.

(c) The financial product provider calculates the RELIB monthly Annuity Payment by aggregating the EQRAT Payments that relate to the SPV pool of EQRAT Consumers, and multiplying each months value by the percentage of the pool expected to be alive, at that date, as dictated by the mortality statistics agreed between the financial product provider and the banker. The mortality statistics agreed maybe as published in the book of deaths, or some modification of that publication.

The resulting schedule of payments is known as EQRAT Schedule A.

The sum of these EQRAT payments equals the bankers RELIB Monthly Annuity Payment obligation to the financial product provider's SPV. The present value of Schedule A is calculated by discounting the expected obligations at the bankers' lending rate (fixed rate less RELIB A Margin).

The same process is followed for calculation of the banks CEQRAT RELIB Monthly Annuity Payment obligation to the financial product provider's SPV. Firstly, the financial product provider calculates the CEQRAT RELIB monthly Annuity Payment by indexing the prior months CEQRAT payment by monthly CPI. The monthly CEQRAT Payments that relate to the SPV pool of CEQRAT Consumers are then aggregated, and multiplying each month's value by the percentage of the pool expected to be alive, at that date, as dictated by the mortality statistics agreed between the financial product provider and the bank.

The resulting schedule of payments is known as CEQRAT, Schedule A.

The CEQRAT example payment of $1,133.69 falls to $1082.85 when actual, rather than average, mortality curves are applied in conjunction with the example CPI compounding at 2.5%. This is a function of the speed of mortality as it approaches average mortality or ‘life expectancy’.

Using the above example for both EQRAT and CEQRAT their Schedule A are illustrated in summary form in the attached spreadsheet that follows.

(d) Schedule EQRAT and CEQRAT B is established by calculating the mortality payments that would be made by the members of the pool in the event that their mortality rate was equal to that derived by applying the mortality statistics agreed between the Banker and the financial product provider. An Example of this is found in the spread sheet above.

The Net Present Value of Schedule B is calculated by discounting the future cashflows of Schedule B at the bankers fixed rate plus the RELIB B Margin.

(e) The SPV then exchanges Schedule A and the Present Value of Schedule A with the Banker such that the Banker pays the Schedule A payments to the SPV and the SPV pays the Schedule A Present Value to the Banker further the SPV also Exchanges Schedule B and the Present Value of Schedule B with the Banker such that the SPV pays the Schedule B payments to the Banker and the Banker pays the Present Value of Schedule B to the SPV.

As part of this process the Banker retains an amount of money that is equal to the Reserve Account.

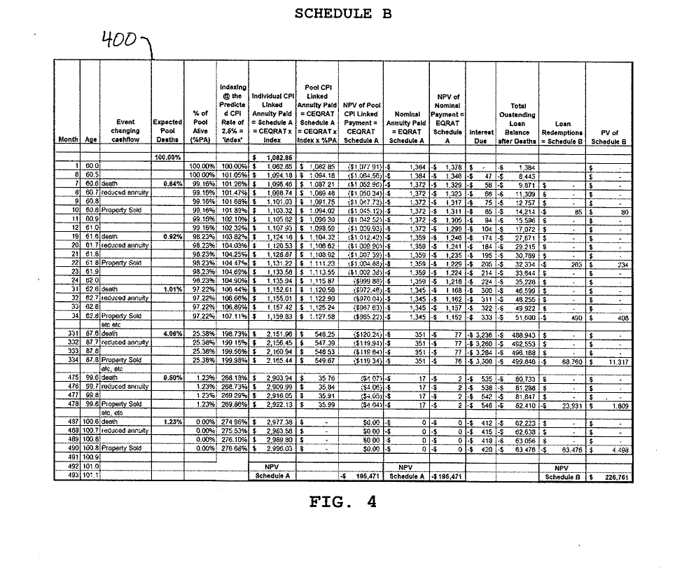

A computer program is included that uses sample data to illustrate this process. This program is termed the “Financial Model For Funding”. The program, in one embodiment, operates via a spreadsheet, a screenshot 400 of which is shown as Schedule B in FIG. 4.

(f) The financial product provider grants a first fixed charge to the Banker over the relevant (C)EQRAT assets of the SPV. These assets take the form of SPV's first registered Mortgage over the (C)EQRAT Consumers property.

The RELIB monthly Pooled Schedule A and Schedule B Payments continue unchanged, independent of a (C)EQRAT consumers actual mortality date until the entire pool is deceased.

(g) Following the death of a participating (C)EQRAT consumer in the pool, the financial product provider will determine the Mortality Payment Date for that Consumer. The Mortality Payment Date is the date a number of months (usually four) from the last EQRAT Payment that occurred prior to the relevant Consumers death.

(h) The Mortality Payments (Schedule B) are calculated using the Mortality Payment Date, Fixed Rate, EQRAT Margin, the relevant EQRAT payment and paid to the SPV on the Mortality Payment Date.

(i) If the loan balance exceeds the property sale price, the consumer will be forgiven the difference.

(j) The Banker is required to release the relevant property Mortgage or asset from the Fixed Charge.

(k) When the last Schedule B payment is made then the RELIB has matured and the Banker releases the contents (if any) of the reserve account back to the SPV.

3. Banker Makes Schedule A Payments to the Financial Product Provider

Following the implementation of the above described cash flow exchange process and the issuance of the RELIB the Banker begins to make the monthly RELIB Schedule A Payment to financial product provider's SPV. The payments are made every month as dictated by Schedule A.

In the case of 1000 EQRAT units applied to the example above, the Banker would make payments equivalent to:

EQRAT Months 1-6:=1000×$1,383−85=$13,838.50.

EQRAT Months 7-12:=1000×$1,372−19=$13,721.90.

On the 7^{th} month, if 0.84% of the pool had not died, the banker would still make the same payment, as Schedule A is dictated by a fixed mortality schedule. As a function of actual mortality differing from expected mortality, the consumer's left in the pool will collectively require a higher or lower payment. A higher payment will be financed from the Reserve Account, and the residual surplus left as a function of a lower payment will be deposited into the reserve account.

In the case of 1000 CEQRAT units applied to the example above, the Banker would make payments equivalent to:

CEQRAT Month 1:=1000×$1,082−85=$10,828.50.

CEQRAT Month 7:=1000×$1,096−46=$10,964.60.

It is noted that the CEQRAT payment calculation is dependent upon the dual paths of actual CPI released and mortality.

Whilst the banker payment to the financial product provider will not vary as a function of pool mortality, it will vary as a function of the CPI release. As in the EQRAT example, Schedule A deficits (as a function of delayed mortality) are funded from the reserve account. Equivalently, the residual surplus left as a function of a lower payment because of accelerated mortality, will be deposited into the reserve account.

The dual path dependency of payment obligation variation to the CEQRAT Schedule A, is best explained by way of two examples.

### EXAMPLE 1

Increased CPI (4%) and delayed mortality at 6 months from 0.84% to 0.20%.

### EXAMPLE 2

Decreased CPI (1%) and accelerated mortality at 6 months from 0.84% to 2.00%.

TABLE 1
Screenshots of a Spreadsheet Program
Calculating the Monthly CEQRAT Payments Due

| | | | | | | | | | | | | Reserve |
|---|---|---|---|---|---|---|---|---|---|---|---|---|
| | | | | | | | Pool CPI | Original | Original Pool | | | Account |
| | | | | | | Individual | Linked | Individual CPI | CPI Linked | | | funds |
| | | | | | Indexing | CPI Linked | Annuity paid = | Linked Annuity | Annuity paid = | | | payment |
| | | | | | @ the | Annuity paid = | CEQRAT | Paid = | CEQRAT | | | change as a |
| | | Event | Expected | | ACTUAL | Schedule A = | Schedule A = | Scheduled A = | Scheduled A = | | Bank funds | function of |
| | | changing | Pool | % of Pool | CPI Rates = | CEQRAT × | CEQRAT × | CEQRAT × | CEQRAT × | Change in | CPI change | delayed |
| Month | Age | cashflow | Deaths | Alive (% PA) | ‘Index’ | Index | Index % % PA | Index | Index % %PA | payment | component | morality |
| — | | | | | [symbol] | [symbol] | | | | | | |
| 1 | [symbol] | | | [symbol] | [symbol] | [symbol] | [symbol] | [symbol] | [symbol] | [symbol] | [symbol] | [symbol] |
| 2 | [symbol] | | | [symbol] | [symbol] | [symbol] | [symbol] | [symbol] | [symbol] | [symbol] | [symbol] | [symbol] |
| 3 | [symbol] | | | [symbol] | [symbol] | [symbol] | [symbol] | [symbol] | [symbol] | [symbol] | [symbol] | [symbol] |
| 4 | [symbol] | | | [symbol] | [symbol] | [symbol] | [symbol] | [symbol] | [symbol] | [symbol] | [symbol] | [symbol] |
| 5 | [symbol] | | | [symbol] | [symbol] | [symbol] | [symbol] | [symbol] | [symbol] | [symbol] | [symbol] | [symbol] |
| 6 | [symbol] | | | [symbol] | [symbol] | [symbol] | [symbol] | [symbol] | [symbol] | [symbol] | [symbol] | [symbol] |
| 7 | [symbol] | [symbol] | [symbol] | [symbol] | [symbol] | [symbol] | [symbol] | [symbol] | [symbol] | [symbol] | [symbol] | [symbol] |
| 8 | [symbol] | [symbol] | | [symbol] | [symbol] | [symbol] | [symbol] | [symbol] | [symbol] | [symbol] | [symbol] | [symbol] |
| 9 | [symbol] | | | [symbol] | [symbol] | [symbol] | [symbol] | [symbol] | [symbol] | [symbol] | [symbol] | [symbol] |
| 10 | [symbol] | [symbol] | | [symbol] | [symbol] | [symbol] | [symbol] | [symbol] | [symbol] | [symbol] | [symbol] | [symbol] |
| | | | | | | | | | | | | Reserve |
| | | | | | | | Pool CPI | | Original Pool | | | Account |
| | | | | | | Individual | Linked | | CPI Linked | | | funds |
| | | | | | Indexing | CPI Linked | Annuity paid = | | Annuity paid = | | | payment |
| | | | | | @ the | Annuity paid = | CEQRAT | | CEQRAT | | | change as a |
| | | Event | Expected | | ACTUAL | Schedule A = | Original | Scheduled A = | Scheduled A = | | Bank funds | function of |
| | | changing | Pool | % of Pool | CPI Rates = | CEQRAT × | CEQRAT × | Schedule A | CEQRAT × | Change in | CPI change | delayed |
| Month | Age | cashflow | Deaths | Alive (% PA) | ‘Index’ | Index | Index % % PA | cashflow | Index % %PA | payment | component | morality |
| — | | | | | [symbol] | [symbol] | | | | | | |
| 1 | [symbol] | | | [symbol] | [symbol] | [symbol] | [symbol] | [symbol] | [symbol] | [symbol] | [symbol] | [symbol] |
| 2 | [symbol] | | | [symbol] | [symbol] | [symbol] | [symbol] | [symbol] | [symbol] | [symbol] | [symbol] | [symbol] |
| 3 | [symbol] | | | [symbol] | [symbol] | [symbol] | [symbol] | [symbol] | [symbol] | [symbol] | [symbol] | [symbol] |
| 4 | [symbol] | | | [symbol] | [symbol] | [symbol] | [symbol] | [symbol] | [symbol] | [symbol] | [symbol] | [symbol] |
| 5 | [symbol] | | | [symbol] | [symbol] | [symbol] | [symbol] | [symbol] | [symbol] | [symbol] | [symbol] | [symbol] |
| 6 | [symbol] | | | [symbol] | [symbol] | [symbol] | [symbol] | [symbol] | [symbol] | [symbol] | [symbol] | [symbol] |
| 7 | [symbol] | [symbol] | [symbol] | [symbol] | [symbol] | [symbol] | [symbol] | [symbol] | [symbol] | [symbol] | [symbol] | [symbol] |
| 8 | [symbol] | [symbol] | | [symbol] | [symbol] | [symbol] | [symbol] | [symbol] | [symbol] | [symbol] | [symbol] | [symbol] |
| 9 | [symbol] | | | [symbol] | [symbol] | [symbol] | [symbol] | [symbol] | [symbol] | [symbol] | [symbol] | [symbol] |
| 10 | [symbol] | [symbol] | | [symbol] | [symbol] | [symbol] | [symbol] | [symbol] | [symbol] | [symbol] | [symbol] | [symbol] |

The bank is liable for cashflow variance as a function of CPI changes due to the original CPI swap contract.

4. Annuity Payments Received by Financial Product Provider

The financial product provider's SPV receives the Monthly RELIB Annuity Payment (Schedule A) and upon receipt splits the payment into 1000 parts, each part being an amount equal to a CEQRAT or EQRAT Payment obligation to a consumer in the SPV pool.

One of those parts as calculated above in (l) is $1,383.85 and this is paid to our Example EQRAT Consumer.

In reality, the Monthly RELIB Annuity Payment will be the summation of obligations due by the SPV to consumers of different ages, sexes and marital status. Some consumers will choose a CEQRAT and others a EQRAT, but each will offer real estate security that have different values.

Subsequently, the numerical division of the summation of all Monthly RELIB Annuity Payment amounts, by the number of consumers in the pool, is a simplified example.

5. Financial Product Provider Makes Annuity Payments to Consumer

The (C)EQRAT Payments are made to each (C)EQRAT Consumer who is a member of Financial product provider's SPV Pool. (C)EQRAT Consumers continue to receive their payments until the month before the Mortality Payment Date.

6. Annuity Payments Received by Consumer

Each (C)EQRAT Consumer receives their monthly (C)EQRAT payment. The (C)EQRAT contract may state that the Financial product provider will pay the (C)EQRAT payments up to the month of the Mortality Payment date, or it may state that the (C)EQRAT payments cease upon the mortality of the consumer.

7. Consumer Dies Mortality Payment Date is Determined

When the (C)EQRAT Consumer dies the financial product provider is obliged to calculate the Mortality Payment Date. This is calculated by using the following algorithm:

Mortality payment Date Deceased Consumers most recent (C)EQRAT Payment Date plus (usually four) months.

8. Financial Product Provider Calculates the (C)EQRAT Mortality Payment

The (C)EQRAT Mortality Payment is calculated by using the following Algorithm.
(a) Calculate the Term of Life e.g. if the 1st (C)EQRAT payment occurred on Jan. 1, 2004 and the Mortality Payment Date is Jan. 12, 2018 then there have been 180 payments made up to the payment made on the Mortality Payment Date so the term of life is 180.
(b) Calculate the Future Value of the (C) EQRAT payments using the Fixed rate, the EQRAT margin, EQRAT payment and the term of life:
   FV=[1+((fixed rate+EQRAT (Term Of life)−1)/(fixed rate+EQRAT margin)]* EQRAT Payment=$478,865.00

However, if the (C)EQRAT payments had ceased at the consumers mortality, and the final mortality payment was to be made 4 months after the consumer's death, the calculation would become (using the same EQRAT example):
FV=[[1+((fixed rate+EQRAT margin⁽¹⁷⁶⁾−1)/(fixed rate+EQRAT margin)]*EQRAT Payment]*(1+fixed rate)⁴=$473,274.00

NOTE: Whilst a CEQRAT consumer receives CPI Linked payments, their CEQRAT Mortality Payment is calculated using the EQRAT nominal loan formulae.

9. Financial Product Provider Advises the Estate of (C)EQRAT Consumer, The Mortality Payment Obligation, Seeking Payment Directly, or via Sale of Deceased Consumers House

The (C)EQRAT Facility Agreement states that the (C)EQRAT Consumer's estate must pay the (C)EQRAT Mortality Payment on the Mortality Payment Date and that this (C)EQRAT Mortality Payment can if necessary, be funded by financial product provider liquidating the relevant Real Estate, over which it holds a mortgage.

To this end the financial product provider is empowered under the (C)EQRAT Facility Agreement to take possession of the Real Estate and take whatever reasonable steps are necessary (including renovation) to prepare the Real Estate for sale and instruct a Real Estate Agent to sell the Property.

Prior to that step being taken, the following procedure is to be followed:
(i) The estate is advised of the (C)EQRAT Mortality payment obligation.
(ii) The estate is advised that either the payment can be made directly, and if so, the mortgage will be released to the estate. This gives the opportunity for the beneficiaries of the consumer's estate to retain the house.
(iii) If the estate waives its' right to make the payment directly, the house will be sold under the supervision of the financial product provider.
(iv) Upon sale, the BEG is deducted from the net sale proceeds and paid to the estate.
(v) The (C)EQRAT Mortality payment is then deducted and paid to the financial product provider. As per the terms of the (C)EQRAT facility agreement, if there are insufficient funds, the difference is ‘forgiven’.

In regard to point (v), if the probability that the house value has exceeded the (C)EQRAT Mortality payment obligation (net of the BEG), the estate would be best advised to choose option (iii) and waive its right to make the mortality payment separately.

When the property is sold the Sale Proceeds are held in Trust by financial product provider until the Mortality Payment Date arrives at which time the (C)EQRAT Mortality Payment is deducted from the Sale proceeds and the remainder (if any) is refunded to the deceased Consumers Estate along with any interest that may have accrued in favour of the deceased estate on the Sale proceeds.

The financial product provider's SPV now ceases to make (C)EQRAT payments to the Consumer.

10. Financial Product Provider Receives (C)EQRAT Mortality Payment

The financial product provider's SPV receives the (C)EQRAT Mortality payment of $478,865.00.

11. Independent of a Mortality Event, the Financial Product Provider makes the Scheduled RELIB Mortality Payment (Schedule B) to the Banker

The RELIB Mortality Payment is paid to the banker as per Schedule B and the banker hence forth reduces the RELIB Annuity Payment as per Schedule A by an amount equal to the original relevant (C)EQRAT Payment, adjusted for scheduled mortality.

12. Banker Releases Mortgage

The Banker now releases the relevant Real Estate asset from the fixed charge so that the title can be transferred into the name of the purchaser.

At least one embodiment provides a number of advantages over traditional retirement funding financial products such as term of life annuities and reverse mortgages.

Firstly, the retirement product allows a pensioner to draw an annuity for a term of life and pay for that annuity posthumously, so it incorporates the advantage of a traditional reverse mortgage, without the associated risk of the value of the loan exceeding the value of the property resulting in the pensioner being evicted from his or her home. As a corollary, the retirement product removes the risks associated with traditional reverse mortgage products, including mortality risk, interest rate risk and mortgaged asset capital price risk.

Secondly, some embodiments provide the advantage of a regular periodic payment, as would a fixed rate term of life annuity product, but without the need to pay “upfront”. Rather, payment of the purchase consideration for the annuity is subject to security and is only payable upon death of the consumer.

Thirdly, at least one specific embodiment captures an arbitrage. In currently utilized methods, life insurance companies receive annuity payments from insured consumers (premiums) and in return pay the consumers a lump sum in the future based upon mortality. In order the hedge this exposure the life insurers invest the premiums in long term interest rental and dividend bearing assets.

These investments are an inefficient hedge because the yields are low and buying and selling the investments incurs large transaction costs. Further inefficiencies exist because the maturity profile and cash flow of the investments does not match the maturity and cash flow profile of the Policy Liabilities.

Some embodiments provide a method by which life insurance companies may hedge their life policy assets and liabilities, as transaction costs are low and maturity profiles are more closely matched. This creates an arbitrage effect where the life insurance companies can borrow money at low rates by issuing life insurance policies and then lend that money to the financial product provider using much higher rates whilst maintaining a matched cash flow profile with a maturity profile based upon human mortality rather than fixed or perpetual maturities of financial assets and real estate. In this embodiment the SPV, financial product provider and banker could all be just one institution that being the Life Insurance Company and the entire process would be implemented as a balance sheet transaction contained within the single legal entity of the Life Insurance Company.

It will be understood that the algorithms and methodologies described herein may be implemented on a computing system. For example, the method of calculating an annuity payment and providing the annuity payment to a consumer may be performed on a computing system. An example of such a system has been described.

The computing system may also be utilized to carry out the steps of providing payments to a consumer.

Furthermore, a computing system may also be utilized to calculate the arbitrage effect discussed above, by monitoring the cash flow profile and the maturity profile, and alerting the financial services provider to any discrepancies between the two quantities.

1. A method of enabling a plurality of consumers to receive a term of life periodic payment from a financial product provider, the method comprising:
securing an interest for a predetermined value over assets owned by the plurality of consumers;
calculating a series of periodic income payments payable to each of the plurality of consumers, the series of periodic income payments being dependent on the expected life expectancy for each of the plurality of consumers;
providing the payments to each of the plurality of consumers until death; and
subsequent to the death of a consumer, recovering a final payment payable to the financial product provider.

2. A method in accordance with claim 1, wherein the series of periodic income payments are calculated by utilizing a future value of the asset, utilizing an estimated present value of the asset, utilizing the future value to calculate a present value, and utilizing the present value and the expected life expectancy of the consumer to calculate the value of each one of the series of periodic income payments.

3. A method in accordance with claim 2, wherein the estimated present value of the asset is adjusted down by a percentage set aside for bequeathment and a predetermined loan to value ratio.

4. A method in accordance with claim 3, further comprising, subsequent to the death of the consumer of the plurality of consumers, calculating the final payment payable to the provider.

5. A method in accordance with claim 4, wherein the final payment is calculated based on a total number of periodic income payments provided to the consumer during their lifetime and a margin lending rate charged by the provider, wherein the final payment from the disposed value of the asset is deducted, and the remaining portion of value of the disposed asset is refunded to an estate of the consumer.

6. A method in accordance with claim 1, further comprising securing a series of term of life annuity payments from a third party, the term of life annuity payments being utilized to provide the series of periodic income payments to the consumer.

7. A method in accordance with claim 6, further comprising pooling obligations of the financial product provider to the plurality of consumers, and cashflow obligations of the plurality of the consumers' assets to the financial product provider.

8. A method in accordance with claim 7, further comprising intermediating an agreement with a third party whereby the present value of the plurality of term of life annuity payments to the plurality of consumers is exchanged for the present value of the plurality of final payments due to the financial product provider.

9. A method in accordance with claim 8, further comprising, subsequent to the death of the consumer, calculating a consideration payment.

10. A method in accordance with claim 9, wherein the consideration payment is calculated by utilizing the total number of periodic income payments provided to the consumer and a margin lending rate charged by the financial product provider, and rendering the consideration payment to the financial product provider in consideration for the series of term of life annuity payments.

11. A method in accordance with claim 6, further comprising providing security to a banker in return for the series of term of life annuity payments made to a special purpose vehicle managed by the financial product provider.

12. A method in accordance with claim 11, wherein the interest is a mortgage over a property owned by the consumer.

13. A method in accordance with claim 12, wherein the security is a charge over the mortgage over the property owned by the consumer.

14. A method in accordance with claim 1, where by the entire process is conducted in the form of a single business operating on a single balance sheet of a single company.

15. A method in accordance claim 4, whereby an investor provides insurance policies to other consumers in return for a periodic payment, the periodic payment being utilized to fund the term of life annuity payments to maintain a matched cash flow profile, whereby an investor charges the financial product provider a margin rate for provision of the term of life annuity payment.

16. A method in accordance with claim 11, wherein the insurance policy is a life insurance policy having a similar maturity profile, thereby creating an arbitrage effect by hedging the life insurance policy liabilities against the assets of the plurality of consumers.

17. A method for enabling a plurality of consumers to receive a term of life period payment from a financial product provider, the method comprising:
securing an interest for a predetermined value over assets owned by the plurality of consumers;
calculating a series of period income payments payable to each of the plurality of consumers;
the series of period income payments being dependent on the expected life expectancy of the plurality of consumers; and
providing a guarantee that the payments will be made to each of the plurality of consumers until death.

18. The method in accordance with claim 17, further comprising providing the period income payments to each of the plurality of consumers until death.

19. The method in accordance with claim 18, further comprising recovering a final payment payable to the financial service provider upon death of a consumer.

20. A computing system for enabling a consumer to receive a term of life periodic payment from a financial product provider in exchange for an interest over an asset owned by the consumer, the computer system comprising;
means for calculating a series of periodic income payments payable to each of a plurality of consumers, the series of periodic income payments being dependent on the expected life expectancy for the each of the plurality of consumers;
means for providing the payments to each of the plurality of consumers until the death of the consumer, and subsequent to the death of the consumer, disposing of the asset to provide a final payment to the financial product provider.

21. The system in accordance with claim 20, further comprising means for storing a contract setting out the terms of an agreement between the consumer and the provider.

22. A system for providing a series of periodic payments to a plurality of consumers from a provider, the system comprising:
means for regulating a legal relationship between the provider and each one of the plurality of consumers, the regulating means having a plurality of predetermined conditions, including a first condition which requires each one of the consumers to render to the provider an interest for a predetermined value over an asset owned by the consumer, a second condition that requires the provider to calculate and render to each one of the plurality of consumers a series of periodic income payments for the lifetime of the consumer, the series of periodic income payments being dependent on the expected life expectancy of the consumer, and a third condition which, on the death of the consumer, allows the provider to dispose of the asset to receive a final payment as consideration for the provision of the series of periodic payments.

23. The system in accordance with claim 22, wherein the legal relationship is effected by a contract.

24. A computing system for enabling a consumer to receive a term of life periodic payment from a financial product provider in exchange for an interest over an asset owned by the consumer, the computer system comprising:
a processor configured to calculate a series of periodic income payments payable to each of a plurality of consumers, the series of periodic income payments being dependent on the expected life expectancy for the each of the plurality of consumers, the processor further configured to provide the payments to each of the plurality of consumers until the death of the consumer, and, subsequent to the death of the consumer, dispose of the asset to provide a final payment to the financial product provider.

25. The system in accordance with claim 24, further comprising memory, wherein the processor is further configured to communicate with the memory and store a contract setting out the terms of an agreement between the consumer and the provider.
